(19) United States
(12) Patent Application Publication
(10) Pub. No.: US 2003/0180120 A1
(43) Pub. Date: Sep. 25, 2003

(54) Nail pack

(76) Inventor: Chun Fu Wu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/391,900

(22) Filed: Mar. 20, 2003

(30) Foreign Application Priority Data
Mar. 22, 2002 (TW) 091203690

(51) Int. Cl. F16B 15/08

(52) U.S. Cl. 411/443

(57) ABSTRACT

A nail pack includes a preset number of T-shaped separate nails, which respectively formed with a sloping insert portion at a lower end of the head. The sloping insert portion has one end formed with a sharp pointed portion of a preset acute angle, and the sharp pointed portion may sink in an upper one of two works to be united by a nail so as to strengthen effectively the tightly uniting force of the nail with the two works. Then the two works are united with better strength more stably.

### BACKGROUND OF THE INVENTION

This invention relates to a nail pack, particularly to one having a plurality of nails connected together, with each nail having a comparatively strong structure.

A conventional nail pack 10 shown in FIGS. 1 and 2 has a number of T-shaped separate nails 11 connected continuously together. Each nail 11 has a head 111 and a shank 112, and the head 111 has a top surface, a bottom surface, a left surface and a right surface all formed flat, forming a rectangular shape. The breadth between the front side and the rear side of the head is a bit larger than the thickness, defining a striking portion 113 of a large dimensioned topside so that a striking device (P) of a nail gun hits on the top surface of the nail to drive the nail into a work (object). The shank 112 has a number of horizontal parallel recessed lines 114 formed on a front side and a rear side.

When separate nails 11 are to be connected together to from a nail pack 10, every two neighboring nails 11 are arranged to have such a height difference that the upper sides of the heads of all nails 11 may form a sloped line of a preset angle so as to match with a sloping cartridge of a common nail gun.

Next, as shown in FIG. 3, a common nail pack 10, whether being flat or sloping, is to have each separate nail 11 to be driven with its shank into two works (objects) 12 by a nail gun for tightly uniting the two works together, and aside from the shank 112 used to keep tightly together the two works 12, the horizontal recessed lines 114 augment friction resistance to heighten uniting force of the nail against the two works 12. However, the horizontal recessed lines 114 are the shortest ones formed in the shank 112 with the most weak friction resistance, with which the two works are united together. And it is not the most desirable condition of uniting together the two works. Further, the head 111 of the nail 11 is used only for striking, with its lower side only resting on the works, with no aid to the uniting force of the nail with the works 12 at all.

### SUMMARY OF THE INVENTION

An object of the invention is to offer a nail pack improved in the head structure of each separate nail by forming a sloping insert portion at a lower end of the head of each separate nail, and the sloping insert portion has in one end a sharp pointed portion of a preset angle. Then the sharp pointed portion may sink into an upper surface of an upper work of two works to be united by a nail, effectively heightening the tightly uniting force of the nail with the two works.

The nail pack in the present invention has a preset number of T-shaped nails continuously connected together. Each nail has a head and a shank, and each head has a flat top surface, and a contact line is formed respectively to extend from a left and a right vertical side of the head to a bottom of the shank. The sloping insert portion is formed symmetrically at the bottom of the head and a front and a rear side of the shank. And the two ends of the sloping insert portion contact with two lower ends in an inclined angle. Further, one end of the sloping insert portion and one bottom end of the head define a sharp pointed portion of a preset angle.

Then when a separate nail is driven in two works, the sharp pointed portion sinks in an upper surface of an upper one of the two works united by the nail, strengthening the tightly uniting force of the nail with the two works, which are then united with better strength more stably.

### BRIEF DESCRIPTION OF DRAWINGS

This invention will be better understood by referring to the accompanying drawings, wherein:

FIG. 1 is a perspective view of a conventional nail pack;

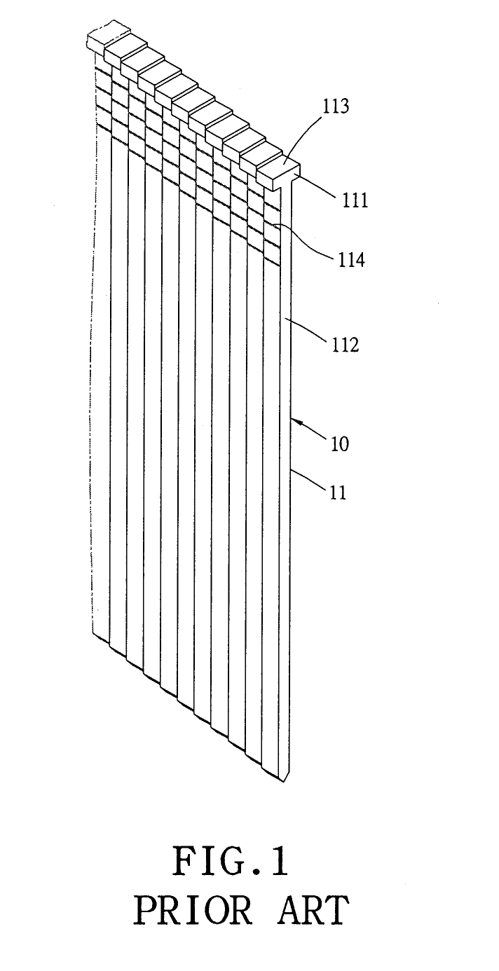

FIG. 2 is a front view of the conventional nail pack;

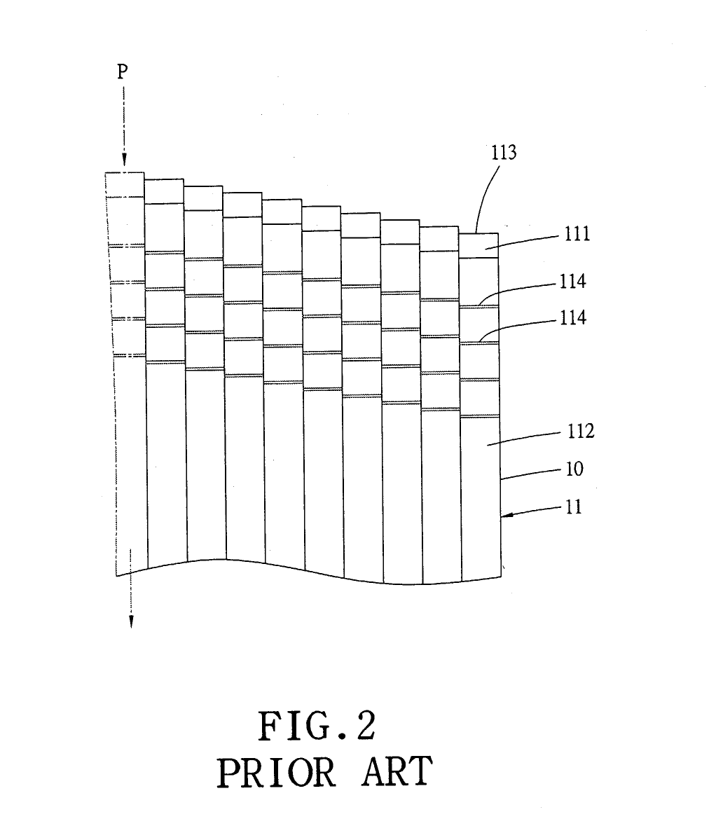

FIG. 3 is a front cross-sectional view of the nail of the conventional nail pack driven in two works;

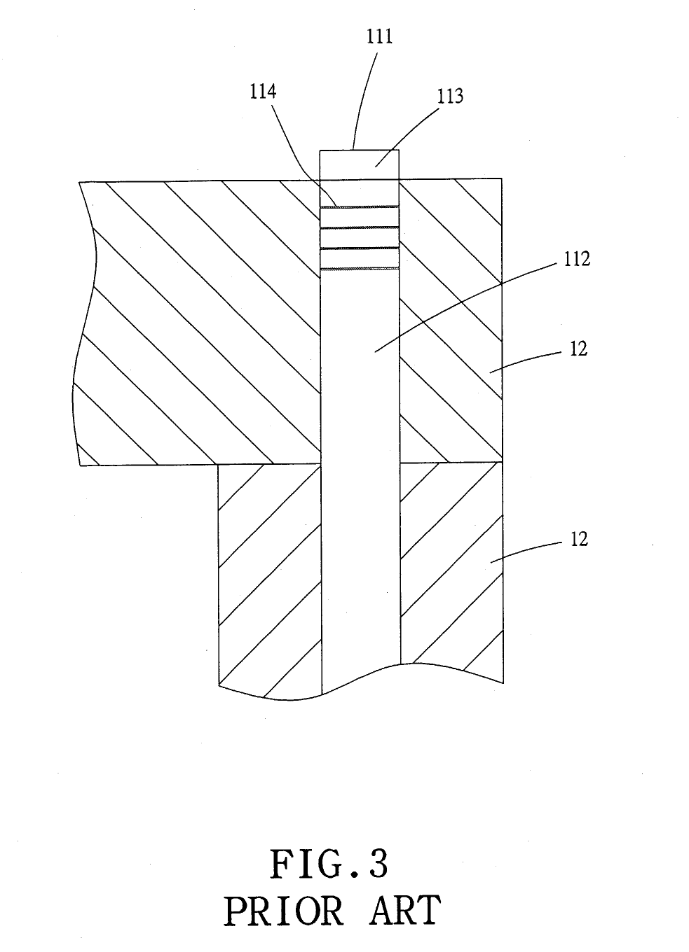

FIG. 4 is a perspective view of a preferred embodiment of a nail pack in the present invention;

FIG. 5 is a plane view of the preferred embodiment of the nail pack in the present invention;

FIG. 6 is a front cross-sectional view of the preferred embodiment of a nail of the nail pack driven in two works in the present invention; and,

FIG. 7 is a side cross-sectional view of two nails of the nail pack driven in two works in the present invention.

### DETAILED DESCRIPTION OF THE PREFERRED EMBODIMENT

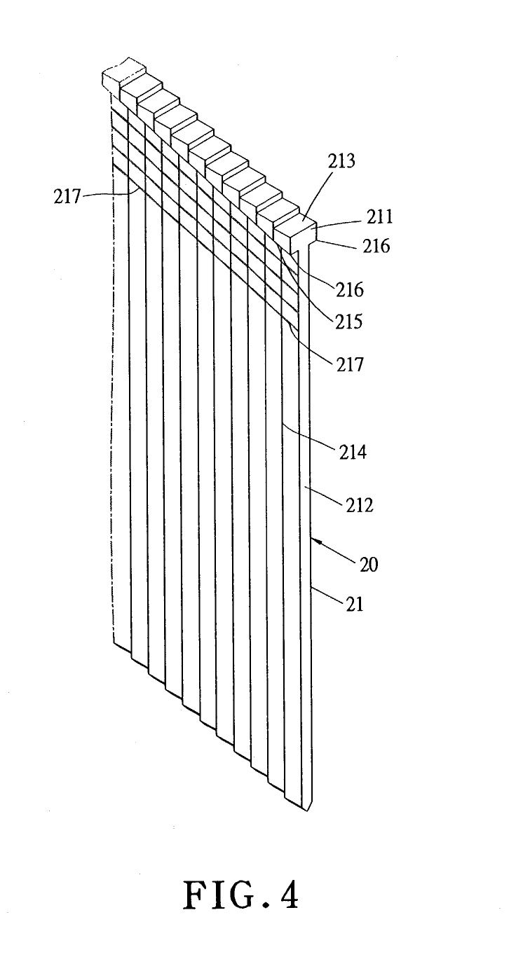

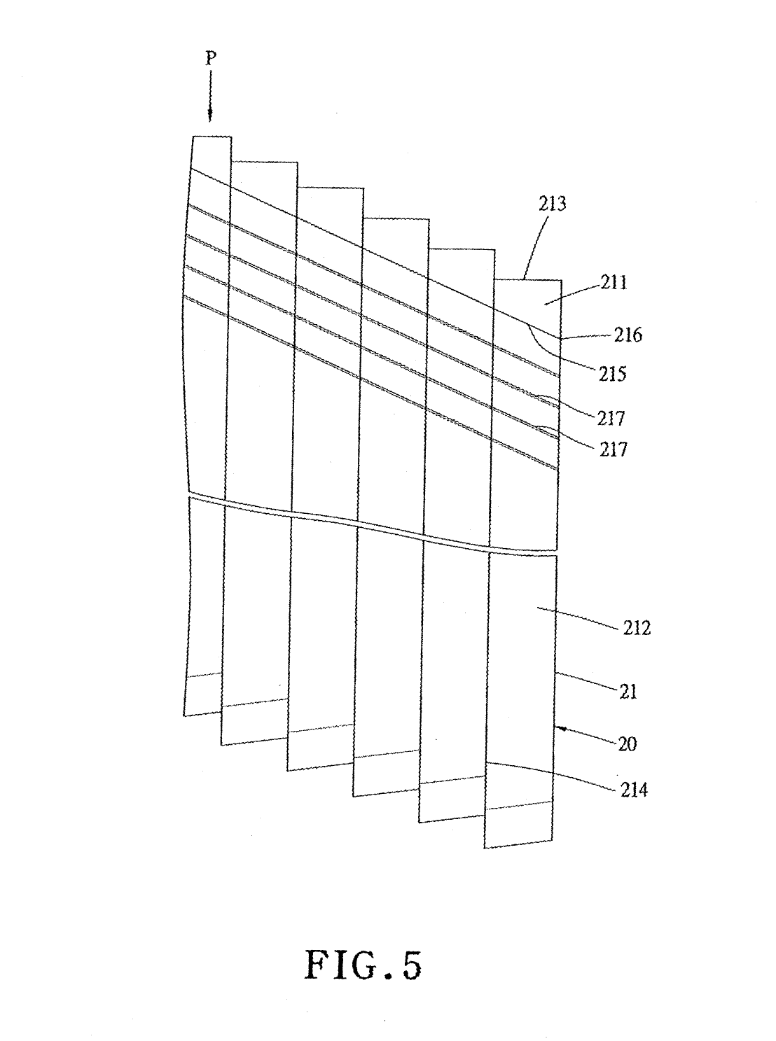

A preferred embodiment of a nail pack 20 in the present invention, as shown in FIGS. 4 and 5, includes a preset number of T-shaped separate nails 21, and each nail 21 has a head 211 and a shank 212. The head 211 has a flat top striking surface 213, and two opposite vertical connecting sides 214 are formed to extend from under the head 211 to the bottom end of the shank so that the shank 212 of each nail 21 may be adhered together one by one with glue to form the nail pack 20. In connecting together the nails 21 into a nail pack 20 with glue, every neighboring two nails have a height difference to make a sloping line respectively at an upper side and at the lower side of the pack.

Besides, the connecting lines of the bottom side of the head 211 with the front vertical side and the rear vertical side of the shank 212 define a sloping insert portion 215, and the sloping insert portion 213 has two ends contacting with the two bottom sides of the head 211 in a sloping condition, and further one end of the sloping insert portion 215 and one lower end of the head 211 defines a sharp pointed portion 216. In addition, a number of inclined parallel recessed lines 217 are formed on the front and the rear surface of the shank 212 in parallel to the sloping insert portion 215 in the same sloping direction.

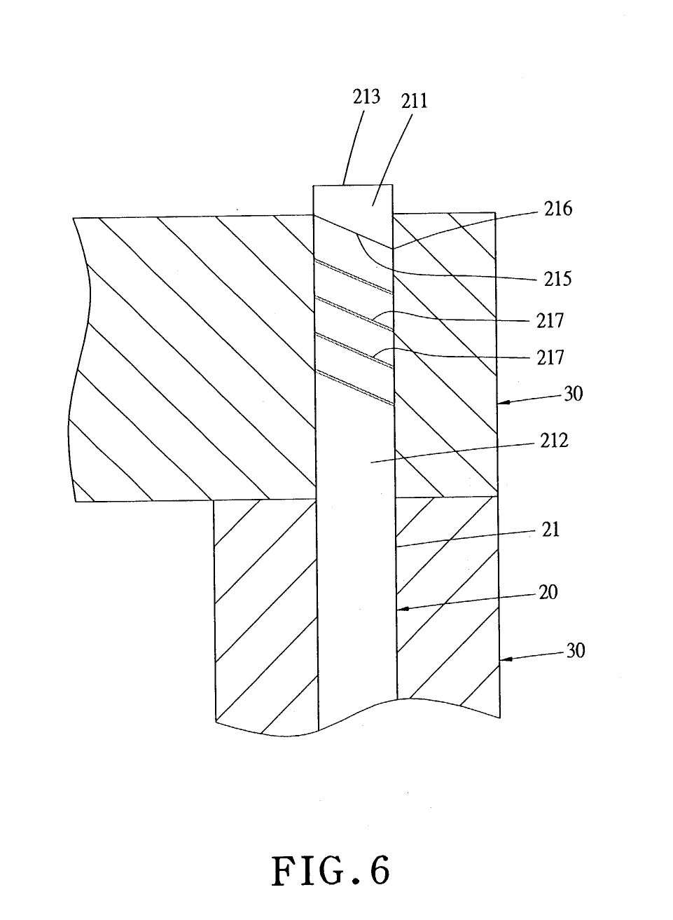

Next, the function of the head 211 of each nail11 is going to be described as follows. As shown in FIGS. 5 and 6, in using the nail pack, it is to be placed in a sloping cartridge of a nail gun, and each separate nail 21 is to be stricken orderly into two works to be united together by means of a striking device (P) of the nail gun. When the flat top surface 213 of each nail 21 is stricken vertically, the whole nail 21 is driven also vertically into two works without biasing. Then the sloping insert portion 215 of the head 211 has the sharp inclined portions 216 to sink into an upper surface of an upper one of the two works 30 by the striking device (P) and further the whole sloping insert portion 215 deeply sinks in the work 30 so as to strengthen the tightly uniting force of the nail 21 with the two works 30.

Next, special provision of the sloping recessed lines 217 lengthen its length more than those horizontal ones 114 of the conventional nail pack so that the friction resistance is larger between the nail 21 and the two works 30, resulting in better strength than the nails of the conventional nail pack.

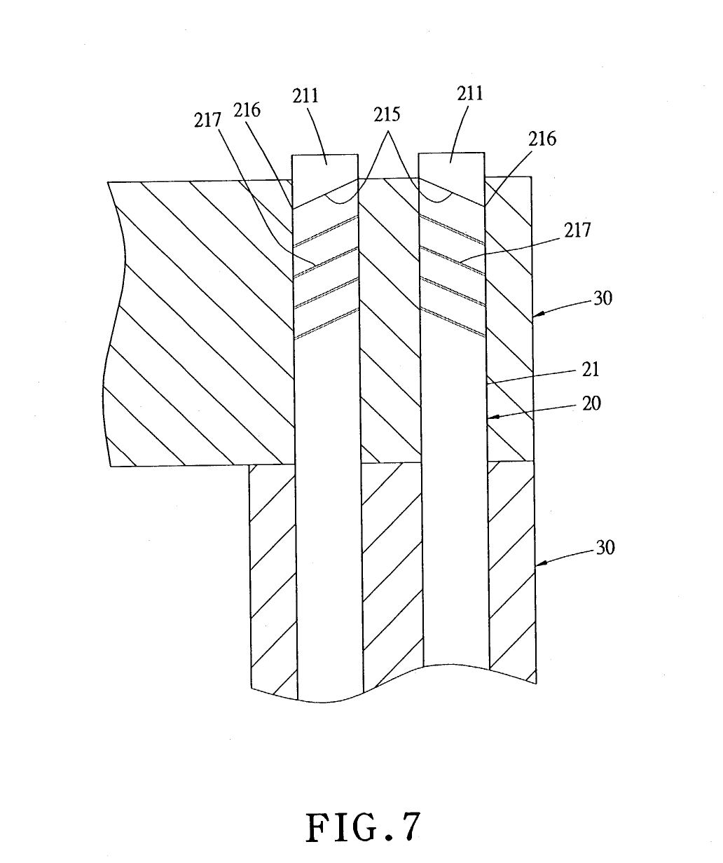

Further, as shown in FIG. 7, common works may often be united together with multiple nails 21 to strengthen the united strength. Then when the nails of the nail pack in the present invention are to be used, it can be arranged that two nails 21 with opposite directions of the sloping insert portions 215 be used. Therefore, the sharp pointed portions 216 of the sloping insert portion 215 of the two nails 21 are embedded in opposite symmetrical condition in the works 30, reinforcing the tightly uniting force of the nails 21 against the two works 30.

While the preferred embodiment of the invention has been described above, it will be recognized and understood that various modifications may be made therein and the appended claims are intended to cover all such modifications that may fall within the spirit and scope of the invention.

What is claimed is:

1. A nail pack comprising a preset number of separate T-shaped nails continuously connected together, each said nail having a head and a shank, said head having a flat top surface, a contacting side vertically formed respectively to extend from a left and a right side of said top surface of said head to a lower end of said shank, said nails adhered one by one with glue to become said nail pack; and,
Characterized by a sloping insert portion formed by a bottom of said head and a front and a rear side of said shank, said sloping insert portion having two ends connected to a bottom end of two sides of said head in an inclined condition, one end of said sloping insert portion and one bottom end of said head defining a sharp pointed portion of an acute angle so as to strengthen tightly uniting force of said nail with two works united.

2. The nail pack as claimed in claim 1, wherein said front and said rear side of said shank are formed with a preset number of sloping recessed lines in parallel to said sloping insert portion.

3. The nail pack as claimed in claim 1, wherein each said nail of said nail pack has a height difference from one another in such a way that said sloping portions and said inclined recessed lines of all said nails are positioned in a sloping condition in a preset angle after said nails are connected together to form said nail pack.
